(19) United States
(12) Patent Application Publication
(10) Pub. No.: US 2002/0186470 A1
(43) Pub. Date: Dec. 12, 2002

(54) Compact optic for displaying spatial light modulators

(75) Inventor: Paul E. Weissman, Brewster, NY (US)

Correspondence Address: AKIN, GUMP, STRAUSS, HAUER & FELD, L.L.P., ONE COMMERCE SQUARE, SUITE 2200, 2005 MARKET STREET, PHILADELPHIA, PA, 19103, US

(73) Assignee: Martin Shenker Optical Design, Inc.

(21) Appl. No.: 10/126,194

(22) Filed: Apr. 18, 2002

Related U.S. Application Data
(60) Provisional application No. 60/285,498, filed on Apr. 20, 2001.

(51) Int. Cl. G02B 5/30; G02B 27/28

(52) U.S. Cl. 359/487; 359/494

(57) ABSTRACT

An optical system for presenting a visual display includes a light source, a polarity-reversing polarizer-analyzer beam splitting cube, and a viewing area that receives light of a first polarity from the light source. The first polarity light contains image information. The cube has a plurality of external surfaces and a bleed through polarity-reversing beam splitting film that selectively passes the first polarity light and converts the passed first polarity light (e.g., S-polarized light) to light of a second polarity (e.g., P-polarized light). The viewing area receives the first polarity light from one of the external surfaces of the cube. In one embodiment, the optical system includes an auxiliary analyzer for blocking the second polarity light from reaching the viewing area. The polarity-reversing film passes through the first polarity light, reflects second polarity light which strikes the film at a specific angle, passes through second polarity light which strikes the film at an angle other than the specific angle, and converts the passed through second polarity light to first polarity light.

### CROSS-REFERENCE TO RELATED APPLICATION

This application claims the benefit of U.S. Provisional Application No. 60/285,498, filed Apr. 20, 2001, entitled “Compact Optic for Displaying Spatial Light Modulators.”

### BACKGROUND OF THE INVENTION

The present invention relates generally to image generating systems, and more particularly to optics arrangements especially suitable for miniaturized image generating systems, such as the miniaturized optics arrangement disclosed in U.S. Pat. No. 5,596,451 entitled “Miniature Image Generator Including Optics Arrangement.”

One of the ongoing challenges facing the manufacture of miniature image generating systems is providing smaller and more durable systems while reducing bleedthrough problems which degrade the quality of images. Miniature image generating systems which are small enough to be mounted onto a helmet or small enough to be supported by a pair of eyeglasses will find a wide variety of uses if they can provide adequate resolution and brightness in a small, low-power, and durable package at a low cost.

Referring to FIGS. 1A and 1B, two different prior art miniature image generator systems will be described. Such systems are described in further detail in U.S. Pat. No. 5,596,451. Like components are designated by like reference numerals throughout the various figures. As shown, each assembly includes a suitable and readily available illumination arrangement 34. Illumination arrangement 34 may be any device or combination of devices that exhibit luminance or may be illumination produced by an optical system that may be focused in proximity to the position occupied by arrangement 34 in the drawings. The purpose of the illuminator is to illuminate the apparent field of view of the image generator. The assemblies also include a suitable and readily available spatial light modulator 36 which is typically and preferably a reflective type light modulator that modulates the light directed into the spatial light modulator by either changing or not changing the polarization of the light depending on the ON/OFF status of each pixel making up the spatial light modulator.

Referring now to FIG. 1A, a first prior art assembly, generally designated by reference numeral 38, will be described in detail. As mentioned above, assembly 38 includes illumination arrangement 34, spatial light modulator 36, and an optics arrangement 40. Optics arrangement 40 includes a first member, specifically a mirror 42 having a curved light-reflecting surface 44 which is configured to, in cooperation with other members of optics arrangement 40, direct light into an area 46 viewed by a viewer's eye 24. Optics arrangement 40 also includes a second member, which is a polarizer-analyzer beam splitting cube 48, hereinafter referred to as polarizing beam splitting cube 48, having a plurality of external surfaces or faces. As shown in FIG. 1A, illumination arrangement 34 is positioned in proximity to and in optical communication with a first external face 50 of cube 48. If illumination arrangement 34 produces light which is not polarized, an auxiliary polarizer 52 is positioned between illumination arrangement 34 and face 50 of cube 48. Also, spatial light modulator 36 is positioned in proximity to and in optical communication with a second external face 54 of cube 48 and mirror 42 is positioned in proximity to a third face 56 of cube 48 and a quarter wave plate 58 is positioned between mirror 42 and face 56 of cube 48.

Still referring to FIG. 1A, the operation of the assembly will be described. Polarizing beam splitting cube 48 includes a polarizing beam splitting film or layer 64 positioned within cube 48 such that one side of film 64 faces external faces 50 and 54 of cube 48, and the other side of film 64 faces external face 56 and a fourth external face 66 of cube 48. As indicated by lines 60 and 62, which represent light provided by illumination arrangement 34, light produced by illumination arrangement 34 is linearly polarized by auxiliary polarizer 52 such that S-polarized light is directed into film 64 within cube 48. Continuing now with the operation of the assembly, since film 64 is a polarizing beam splitting film, the majority of the S-polarized light 60 is directed into spatial light modulator 36. Spatial light modulator 36 is a reflective spatial light modulator having a reflective surface and a light modulating medium, in this case a ferroelectric liquid crystal layer, which is switchable between different states. The reflective surface and the modulating medium cooperate to act on light in ways that form an overall pattern of reflected, modulated light, which constitutes a modulation encoding of a picture which may be viewed.

The intensity of light reflected from a surface depends strongly upon the angle of incidence and the optical properties of the reflector material. The index “S” stands for “senkrecht” which means perpendicular and “P” stands for parallel with respect to the plane of reflection. S-polarized light which is directed into spatial light modulator 36 is modulated by the ferroelectric liquid crystal material such that the overall pattern of reflected, modulated light is a pattern of light of S-polarized light and P-polarized light which is orthogonally polarized to the S-polarized light. At any point in this pattern, the polarization depends on the state of the corresponding pixelated portions of the ferroelectric liquid crystal material through which the S-polarized light from illumination arrangement 34 has passed. Spatial light modulator 36 directs this modulated light back into cube 48 where the light is analyzed by polarizing beam splitting film 64, as will be described immediately below.

The purpose of analyzing the pattern is to decode the polarization modulated pattern and transform it into a brightness modulated pattern which can be viewed and recognized as a display image. As indicated by line 62, the S-polarized light from illumination arrangement 34 which spatial light modulator does not change, and therefore remains S-polarized light, is directed back toward illumination arrangement 34. As indicated by line 60, the S-polarized light from illumination arrangement 34 which spatial light modulator changes to P-polarized light passes through film 64 and is directed toward mirror 42 through quarter wave plate 58. Mirror 42 reflects light 60 back through quarter wave plate 58 which, since light 60 has passed through quarter wave plate 58 twice, changes light 60 back to S-polarized light. And finally, polarizing beam splitting film 64 directs this S-polarized light out of cube 48 through external face 66 into viewing area 46 which extends outwardly from face 66.

The components of the above described arrangement are mutually disposed and the curvature of mirror 42, which in this case is a magnifying mirror, is established so as to produce a viewable magnified image of the pattern of modulated light created at and by spatial light modulator 36. This image is viewable when a viewer places an eye within viewing area 46 which extends outward from the fourth face 66 of cube 48 and when the eye is directed generally toward face 66 of the cube. This viewable image is made luminous by light from illumination arrangement 34 as modulated by the polarization control effected by spatial light modulator 36 in cooperation with polarizing beam splitter film 64 and auxiliary polarizer 52, if included.

Referring to FIG. 1B, an alternative configuration of the above-described prior art assembly, generally indicated by reference numeral 68, will be described. In this configuration, all of the components making up the assembly are the same as those described above. However, spatial light modulator 36 is positioned adjacent to face 66 of cube 48 and the assembly is viewed from viewing area 46 which is now located adjacent to face 54 of cube 48. This configuration operates in a similar manner to the assembly shown in FIG. 1A except as shown by lines 70 and 72, which indicate light provided by illumination arrangement 34, the light from illumination arrangement 34 is directed through cube 48 in a different way. As shown in FIG. 1B, light 70 and 72 from illumination arrangement 34 passes through auxiliary polarizer 52 which allows light of only one polarization, for example P-polarized light, to pass through into cube 48. Since, film 64 is a polarizing beam splitting film, film 64 allows the vast majority of the P-polarized light to pass through into spatial light modulator 36. As described above, spatial light modulator 36 modulates the light by forming a pattern of S-polarized and P-polarized light which is directed back into cube 48. As indicated by line 70, when spatial light modulator 36 changes the polarization of light 70 to S-polarized light, film 64 directs the light through quarter wave plate 58 into mirror 42. Mirror 42 reflects light 70 back through quarter wave plate and into cube 48. Since quarter wave plate 58 has changed light 70 back to P-polarized light, film 64 allows light 70 to pass through into viewing area 46 such that a virtual image of the pattern of modulated light is viewable from viewing area 46. As indicated by line 72, when spatial light modulator 36 does not change the polarization of light 72, film 64 allows light 72 to pass through film 64 back toward illumination arrangement 34.

Although the above-described prior art arrangements are functional, they suffer from a problem which degrades the quality of the image. When the prior art assembly is a color version of an image generator which must modulate light of different colors, the polarizing beam splitting cube of FIGS. 1A and 1B is not completely efficient at allowing only light of one polarization to pass through the polarizing beam splitting film. Because the prior art film could not be designed to act on light of all wavelengths in the same way, some light of the wrong polarization passes through, or leaks through, the film into viewing area 46 without ever being modulated by spatial light modulator 36. For example, referring back to FIG. 1A, when a color version of the assembly is used, some of the S-polarized light of some of the wavelengths of light which is directed into cube 48 from illumination arrangement 34 leaks through polarizing beam splitting film 64 and passes directly into viewing area 46. This leakage of light reduces the contrast of the image and degrades the quality of the image or causes a ghosting effect. Therefore, the arrangements shown in FIGS. 1A and 1B are best suited for monochrome systems although they can also be used for a color system.

Various methods have been devised in the prior art to solve the bleed through problem, including assemblies using two beam-splitting cubes and assemblies using non-polarizing beam-splitting cubes in combination with addition analyzers. Several such assemblies are described in further detail in U.S. Pat. No. 5,596,451, which is incorporated by reference as if fully set forth herein. Although these alternative methods are efficient in reducing bleedthrough effects, the two-cube assemblies are bulkier than single-cube assemblies, and the non-polarizing beam-splitting cube assembly do not use light as efficiently as polarizing beam-splitting cube assemblies.

Thus, what is needed is a compact assembly, such as a single beam-splitting cube, that uses light efficiently while reducing bleedthrough effects. As will be seen hereinafter, the present invention provides a beam-splitting member having properties which, when combined in novel ways with miniaturized spatial light modulators, is capable of providing compact miniaturized image generating systems that may be used to produce a direct view miniature display with substantially improved image quality over the prior art.

### SUMMARY OF THE INVENTION

In accordance with a preferred embodiment of the present invention, an optical system for presenting a visual display includes an illumination arrangement (i.e., a light source), a polarity-reversing polarizer-analyzer beam splitting cube, and a viewing area. The polarity-reversing polarizer-analyzer beam splitting cube receives light of a first polarity from the light source. The first polarity light contains image information. The polarity-reversing polarizer-analyzer beam splitting cube has a plurality of external surfaces and a bleed through polarity-reversing beam splitting film which selectively passes the first polarity light and converts the passed first polarity light to light of a second polarity. The viewing area receives the first polarity light from a first one of the external surfaces of the polarity-reversing polarizer-analyzer beam splitting cube.

In an alternate embodiment of the present invention, an optical system for presenting a visual display includes a polarity-reversing polarizer-analyzer beam splitting cube, a viewing area, and an auxiliary analyzer. The polarity-reversing polarizer-analyzer beam splitting cube receives light of a first polarity. The first polarity light contains image information. The cube outputs the first polarity light and light of a second polarity from one of the plurality of external surfaces. The viewing area receives the first polarity light outputted from the one external surface of the cube. The auxiliary analyzer is configured to block the second polarity light outputted from the one external surface of the cube from reaching the viewing area.

The polarity-reversing polarizer-analyzer beam splitting cube may include a bleed through polarity-reversing beam splitter film which passes through the first polarity light, reflects second polarity light which strikes the film at a specific angle, passes through second polarity light which strikes the film at an angle other than the specific angle, and converts the passed through second polarity light to first polarity light. The specific angle may be substantially 45 degrees. The first polarity light may be S-polarized light and the second polarity light may be P-polarized light.

### BRIEF DESCRIPTION OF THE SEVERAL VIEWS OF THE DRAWING

The following detailed description of preferred embodiments of the present invention would be better understood when read in conjunction with the appended drawings. For the purpose of illustrating the present invention, there are shown in the drawings embodiments which are presently preferred. However, the present invention is not limited to the precise arrangements and instrumentalities shown. In the drawings:

FIG. 1A is a diagrammatic side view of a first prior art embodiment of a miniaturized image generating system including a polarizing beam splitting cube;

FIG. 1B is a diagrammatic side view of a second prior art embodiment of a miniaturized image generating system including a polarizing beam splitting cube;

FIG. 2A is a diagrammatic side view of a first embodiment of a miniature image generating system designed in accordance with the present invention; and

FIG. 2B is a diagrammatic side view of a second embodiment of a miniature image generating system designed in accordance with the present invention.

### DETAILED DESCRIPTION OF THE INVENTION

Whereas the polarizing beam splitting film 64 of the prior art polarizer-analyzer beam splitting cube permitted some bleed through of light of a first polarization, the present invention employs a bleed through polarity-reversing beam splitting film 102. The bleed through polarity-reversing beam splitting film 102 of the present invention also permits some bleed through of light of a first polarity, rather than reflecting 100% of said polarized light. However, the bleed through polarity-reversing beam splitting film 102 of the present invention reverses the polarity of the bleed through light.

In particular, S-polarized light striking the polarity-reversing beam splitting film 102 at a substantially 45-degree angle is reflected. However, S-polarized light striking the polarity-reversing beam splitting film 102 at oblique angles or angles other than 45 degrees may pass through the film 102. Whereas with a prior art polarizing beam splitting film 64, such bleed through light becomes circularly polarized and the electric vector of the photons may fall in an angle which would still be considered S-polarized light when analyzed, the polarity-reversing beam splitting film 102 forces the photons into an angle that requires a “P” polarizer to analyze them. In this sense, the polarity-reversing beam splitting film 102 can be considered a polarity-reversing coating for pre-polarized light incident on the film 102 that goes in a direction not anticipated by theory.

This polarity feature of the beam splitting film 102, when used in conjunction with an additional analyzer in an optics arrangement, can result in dramatically improved images without adding bulk or decreasing light efficiency. Polarizing beam splitting cubes containing bleed through polarity-reversing beam splitting film 102 are commercially available from Unaxis Corporation, under the brand name HELF beamsplitter coating.

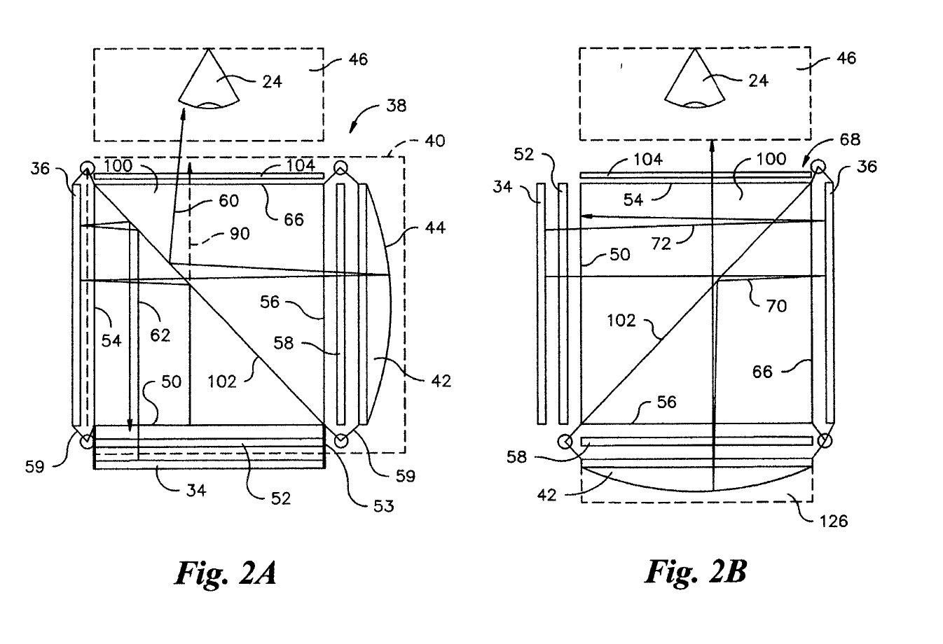

Referring to FIGS. 2A and 2B, wherein like components are designated by like reference numerals throughout the various figures, the general optical elements of optical arrangements for an image generating system, designed in accordance with the present invention, are illustrated. As shown in the figures, each assembly includes a suitable and readily available illumination arrangement 34. In accordance with the present invention, the assemblies shown in FIGS. 2A and 2B include an optics arrangement which, as will be described in more detail hereinafter, cooperates with illumination arrangement 34 and spatial light modulator 36 to generate a viewable image. This optics arrangement may take on a variety of specific configurations, some of which are described below.

Referring now to FIG. 2A, a first embodiment of the present invention, generally designated by reference numeral 38, will be described in detail. Assembly 38 includes illumination arrangement 34, spatial light modulator 36, and an optics arrangement 40. Optics arrangement 40 includes a first member, specifically a mirror 42 having a curved light-reflecting surface 44 which is configured to, in cooperation with other members of optics arrangement 40, direct light into viewing area 46. Optics arrangement 40 also includes a second member, which in this embodiment is a bleed through polarity-reversing polarizer-analyzer beam splitting cube 100, hereinafter referred to as polarity-reversing polarizing beam splitting cube 100, having a plurality of external surfaces or faces. As shown in FIG. 2A, illumination arrangement 34 is positioned in proximity to and in optical communication with a first external face 50 of cube 100. Alternatively, an image of illumination arrangement 34 can be projected to cube 100 through an optical arrangement or device. If illumination arrangement 34 produces light which is not polarized, an auxiliary polarizer 52 is positioned between illumination arrangement 34 and face 50 of cube 100. Illumination arrangement 34 can be readily removably attached adjacent to face 50 of cube 100 to allow for replacement or repair of this component, as indicated generally at 53. Also, spatial light modulator 36 is positioned in proximity to and in optical communication with a second external face 54 of cube 100 and mirror 42 is positioned in proximity to a third face 56 of cube 100 and a quarter wave plate 58 is positioned between mirror 42 and face 56 of cube 100. In this embodiment of the present invention, mirror 42 and/or spatial light modulator 36 are readily adjustably attached adjacent to face 54 and/or face 56, respectively, as indicated generally at 59. This arrangement allows the distance between mirror 42 and face 56 of cube 100 and/or the distance between spatial light modulator 36 and face 54 of cube 100 to be adjusted within a predetermined range of distances thereby providing means for focusing the image generated by the assembly. Alternatively, the spatial light modulator 36 may be remotely located while the image produced by spatial light modulator 36 is projected through an optical device into optical communication with a second external face 54 of cube 100.

Still referring to FIG. 2A, the operation of the assembly will be described. Polarizing beam splitting cube 100 includes a bleed through polarity-reversing polarizing beam splitting film or layer 102 positioned within cube 100 such that one side of film 102 faces external faces 50 and 54 of cube 100, and the other side of film 102 faces external face 56 and a fourth external face 66 of cube 100. As indicated by lines 60 and 62, which represent light provided by illumination arrangement 34, light produced by illumination arrangement 34 is linearly polarized by auxiliary polarizer 52 such that S-polarized light is directed into film 102 within cube 100. It is to be understood that lines 60 and 62 and all other lines subsequently used to trace light through the assemblies are illustrative only and are not intended to represent a ray trace as is commonly performed in the course of an optical design. It is also to be understood that the term S-polarized light is used in the common manner wherein it specifies that the electric vector of the light incident on a reflective surface is perpendicular to the plane of incidence, in this case the plane of the drawing. Continuing now with the operation of the assembly, since bleed through polarity-reversing film 102 is a polarizing beam splitting film, the majority of the S-polarized light 60 is directed into spatial light modulator 36. Because bleed through polarity-reversing film 102 has polarity-reversing characteristics, the portion of S-polarized light 60 that is incident on polarity-reversing film 102 and that is not directed into spatial light modulator 36 passes through polarity-reversing film 102, but is transformed into P-polarized light. Spatial light modulator 36 is a reflective spatial light modulator having a reflective surface and a light modulating medium, such as, by way of example, a ferroelectric liquid crystal layer, which is switchable between different states. The reflective surface and the modulating medium cooperate to act on light in ways that form an overall pattern of reflected, modulated light, which constitutes a modulation encoding of a picture which may be viewed. For this embodiment of the present invention, the S-polarized light which is directed into spatial light modulator 36 is modulated by the spatial light modulator 36 such that the overall pattern of reflected, modulated light is a pattern of light of S-polarized light and P-polarized light which is orthogonally polarized to the S-polarized light. At any point in this pattern, the polarization depends on the state of the corresponding pixelated portions of the ferroelectric liquid crystal material through which the S-polarized light from illumination arrangement 34 has passed. Spatial light modulator 36 directs this modulated light back into cube 100 where the light is analyzed by bleed through polarity-reversing polarizing beam splitting film 102, as will be described immediately below.

The purpose of analyzing the pattern is to decode the polarization modulated pattern and transform it into a brightness modulated pattern which can be viewed and recognized as a display image. As indicated by line 62, the S-polarized light from illumination arrangement 34 which spatial light modulator does not change, and therefore remains S-polarized light, is directed back toward illumination arrangement 34. As indicated by line 60, the S-polarized light from illumination arrangement 34 which spatial light modulator changes to P-polarized light passes through film 102 and is directed toward mirror 42 through quarter wave plate 58. Mirror 42 reflects light 60 back through quarter wave plate 58 which, since light 60 has passed through quarter wave plate 58 twice, changes light 60 back to S-polarized light. And finally, bleed through polarity-reversing polarizing beam splitting film 102 directs this S-polarized light out of cube 100 through external face 66 into viewing area 46 which extends outwardly from face 66.

As will be understood by the above description, two sources of light are directed out of cube 100 through external face 66 into viewing area 46: the S-polarized light which has twice passed through the quarter-wave plate, and the bleed through light that has been transformed into P-polarized light by the bleed through polarity-reversing polarizing beam splitting film 102. Of the two sources, only the S-polarized light contains the desired image from the spatial light modulator; the P-polarized light does not contain useful information. Thus, an auxiliary analyzer 104 is positioned in proximity to and in optical communication with external face 66 of cube 100 to block the P-polarized light and allow only the S-polarized light containing image information to pass to viewing area 46.

The components of the above described arrangement are mutually disposed and the curvature of mirror 42, which in this case is a magnifying mirror, is established so as to produce a viewable magnified image of the pattern of modulated light created at and by spatial light modulator 36. This image is viewable when a viewer places his or her eye 24 within viewing area 46 which extends outward from the fourth face 66 of cube 100 and when the eye is directed generally toward face 66 of the cube 100. This viewable image is made luminous by light from illumination arrangement 34 as modulated by the polarization control effected by spatial light modulator 36 in cooperation with bleed through polarity-reversing polarizing beam splitter film 102 and auxiliary polarizer 52, if included.

In one embodiment of the present invention, the above described assembly forms a real image of illumination arrangement 34 within viewing area 46 and simultaneously forms a virtual image of the pattern of modulated light produced by and at spatial light modulator 36 which is directly visible by a viewer from viewing area 46. The real image of illumination arrangement 34 is formed within viewing area 46 because illumination arrangement 34 is positioned a distance about twice the focal length of mirror 42 from mirror 42 as discussed in U.S. Pat. No. 5,596,451, which also describes the advantages of this arrangement.

Referring to FIG. 2B, an alternative embodiment, generally indicated by reference numeral 68, will be described. In this configuration, all of the components making up the assembly are the same as those described above. However, spatial light modulator 36 is positioned adjacent to face 66 of cube 100 and the assembly is viewed from viewing area 46 which is now located adjacent to face 54 of cube 100. This configuration operates in a similar manner to the assembly shown in FIG. 2A except as shown by lines 70 and 72, which indicate light provided by illumination arrangement 34, the light from illumination arrangement 34 is directed through cube 100 in a different way. As shown in FIG. 2B, light 70 and 72 from illumination arrangement 34 passes through auxiliary polarizer 52 which allows light of only one polarization, for example P-polarized light, to pass through into cube 100. Since film 102 is a polarizing beam splitting film, film 102 allows the vast majority of the P-polarized light to pass through into spatial light modulator 36. In addition, because film 102 is a bleed through polarity-reversing film, film 102 reverses the polarity of that portion of light that is not passed through, but is rather reflected toward external face 54 to viewing area 46. As described above, spatial light modulator 36 modulates the portion of P-polarized light that passes through film 102 by forming a pattern of S-polarized and P-polarized light which is directed back into cube 100. As indicated by line 70, when spatial light modulator 36 changes the polarization of light 70 to S-polarized light, film 102 directs the light through quarter wave plate 58 into mirror 42. Mirror 42 reflects light 70 back through quarter wave plate and into cube 100. Since quarter wave plate 58 has changed light 70 back to P-polarized light, film 64 allows light 70 to pass through into viewing area 46 such that a virtual image of the pattern of modulated light is viewable from viewing area 46. As described above, the portion of P-polarized light which does not pass through from the illumination arrangement 34 to the spatial light modulator 36 is reflected toward external face 54 to viewing area 46, with its polarization changed to S-polarized light. The S-polarized light does not contain useful information. Thus, an auxiliary analyzer 104 is positioned in proximity to and in optical communication with external face 54 of cube 100 to block the S-polarized light and allow only the P-polarized light containing image information to pass to viewing area 46.

As indicated by line 72, when spatial light modulator 36 does not change the polarization of light 72, film 64 allows light 72 to pass through film 64 back toward illumination arrangement 34.

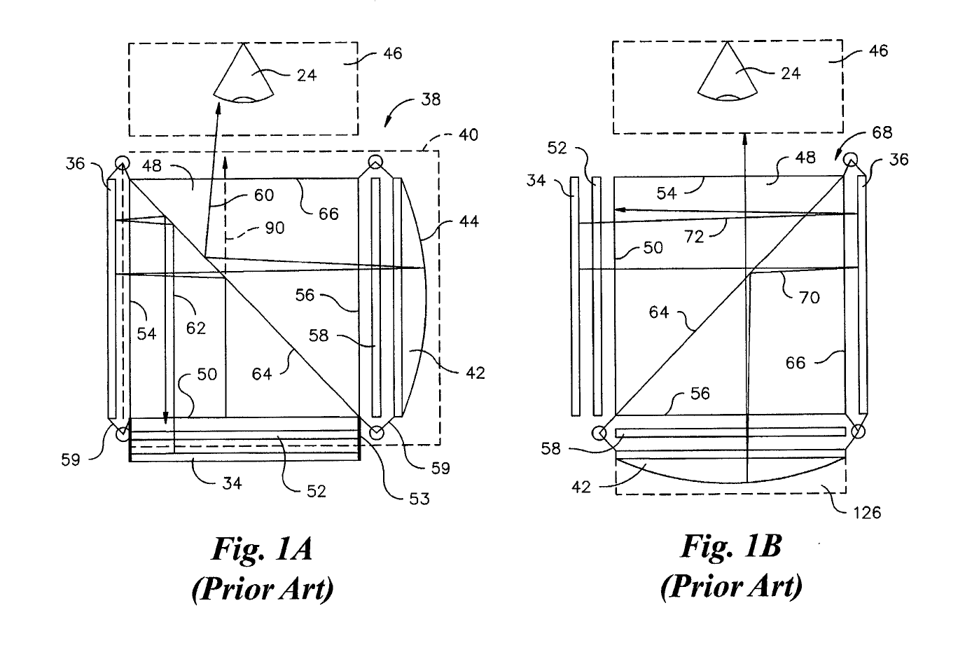

This arrangement affords a number of advantageous features. Whereas the prior art assemblies using two beam-splitting cubes are efficient in reducing bleed through effects while retaining good light transmission, they are bulky and thus undesirable for certain applications. In addition, prior art non-polarizing beam splitting cubes have been employed to reduce bleed through effects, but suffer from an inefficient use of light. The present invention solves the bleed through problem without adding bulk or reducing light transmission, resulting in a ratio of desired light transmission to bleed through light transmission of approximately 600 to 1. The prior art assemblies described in FIGS. 1A and 1B, on the other hand, have transmission ratios of approximately 10 to 1. Thus, it should be apparent to those skilled in the art that the present invention represents a significant improvement in image quality for miniature image generators.

Although only several specific embodiments of the present invention have been described in detail, it should be understood that the present invention may be embodied in many other specific forms without departing from the spirit or scope of the invention. Furthermore, although the embodiments were described as including a beam splitting cube, these optical components are not required to be cubes but instead may take on a wide variety of specific shapes so long as they perform the beam splitting function required by the present invention. For example, the beam splitting cube may be replaced with an appropriately supported bleed through polarity-reversing beam splitting film positioned to provide the same function as the bleed through polarity-reversing beam splitting film internally supported within the cubes described above.

Although each of the above described embodiments have been describe with the various components having particular respective orientations, it should be understood that the present invention may take on a wide variety of specific configurations with the various components being located in a wide variety of positions and mutual orientations and still remain within the scope of the present invention. Quarter wave plates, half wave plates, mirrors, auxiliary polarizers, auxiliary analyzers, and other conventional optical elements may be incorporated in order to configure an assembly designed in accordance with the present invention in a wide variety of particular configurations. Additional lenses, mirrors or other light control components such as diffusers, lenslets, and holographic optical elements, among others, may be incorporated into the illuminator to control or to make efficient or effective use of the light emitted by the source. Further, additional components having optical power may be included which operate in conjunction with the magnifying mirror as a means to determine the position of the viewing region relative to the other parts of the arrangement or to control the field of view, resolution, aberrations or other optical characteristics of the viewable image. The function and use of such additional components are held to be familiar to those skilled in the art and are therefore to be regarded as falling within the scope of the present invention. The present invention equally applies to all of these variations. As described in detail in U.S. Pat. No. 5,808,800, for some types of illumination arrangements, additional mirrors, quarter or half wave plates, and other optical elements may be added to the present invention in appropriate locations in order to redirect and convert portions of the wasted light back into the assembly so that it may be used to improve the efficiency of the assembly.

It will be appreciated by those skilled in the art that changes could be made to the embodiments described above without departing from the broad inventive concept thereof. It is understood, therefore, that this invention is not limited to the particular embodiments disclosed and is not intended to exclude known equivalents, thus it is intended to cover modifications within the spirit and scope of the present invention.

What is claimed is:

1. An optical system for presenting a visual display, the system comprising:
(a) a light source;
(b) a polarity-reversing polarizer-analyzer beam splitting cube which receives light of a first polarity from the light source, the first polarity light containing image information, the cube having a plurality of external surfaces and a bleed through polarity-reversing beam splitting film which selectively passes the first polarity light and converts the passed first polarity light to light of a second polarity; and
(c) a viewing area for receiving the first polarity light from a first one of the external surfaces of the cube.

2. The system of claim 1 further comprising:
(d) a spatial light modulator in optical communication with the cube and the light source, the modulator receiving the first polarity light from the light source, modulating the first polarity light, and directing the modulated light through the cube into the viewing area.

3. The system of claim 2 wherein the modulator includes a reflective surface and a light modulating medium which is switchable between different states.

4. The system of claim 3 wherein the light modulating medium is a ferroelectric liquid crystal layer.

5. The system of claim 2 wherein the modulator converts the first polarity light received from the light source to the second polarity light, and sends the second polarity light through the polarity-reversing film and out of the first external surface of the cube.

6. The system of claim 2 wherein the modulated light is a pattern of the first polarity light and the second polarity light, the second polarity light being orthogonally polarized to the first polarity light.

7. The system of claim 1 further comprising:
(d) a light-reflecting surface; and
(e) a quarter wave plate in optical communication with the light-reflecting surface, the quarter wave plate being located between a second one of the external surfaces of the cube and the light-reflecting surface, wherein the second polarity light passes through the polarity-reversing film and travels to the light-reflecting surface via the quarter wave plate.

8. The system of claim 7 wherein the second polarity light is reflected by the light-reflecting surface, travels through the quarter wave plate a second time, the second polarity light is converted to the first polarity light, and the converted first polarity light is outputted from the first surface of the cube.

9. The system of claim 7 wherein the light-reflecting surface is a magnifying mirror having a curved light-reflecting surface which is configured to direct light received from the light source into the viewing area.

10. The system of claim 1 wherein the polarity-reversing film of the cube passes through the first polarity light, reflects second polarity light which strikes the film at a specific angle, passes through second polarity light which strikes the film at an angle other than the specific angle, and converts the passed through second polarity light to first polarity light.

11. The system of claim 10 wherein the specific angle is substantially 45 degrees.

12. The system of claim 1 further comprising:
(d) an auxiliary analyzer configured to block the second polarity light received from the first external surface of the cube, the auxiliary analyzer being located between the first external surface of the cube and the viewing area.

13. The system of claim 1 further comprising:
(d) an auxiliary polarizer which polarizes light received from the light source that is not polarized, the auxiliary polarizer being located between the light source and a second one of the external surfaces of the cube.

14. The system of claim 1 wherein the first polarity light is S-polarized light and the second polarity light is P-polarized light.

15. An optical system for presenting a visual display, the system comprising:
(a) a polarity-reversing polarizer-analyzer beam splitting cube which receives light of a first polarity, the first polarity light containing image information, the cube having a plurality of external surfaces, the cube outputting the first polarity light and light of a second polarity from one of the plurality of external surfaces;
(b) a viewing area for receiving the first polarity light outputted from the one external surface of the cube; and
(c) an auxiliary analyzer configured to block the second polarity light outputted from the one external surface of the cube from reaching the viewing area.

16. The system of claim 15 wherein the polarity-reversing polarizer-analyzer beam splitting cube includes a bleed through polarity-reversing beam splitting film which passes through the first polarity light, reflects second polarity light which strikes the film at a specific angle, passes through second polarity light which strikes the film at an angle other than the specific angle, and converts the passed through second polarity light to first polarity light.

17. The system of claim 16 wherein the specific angle is substantially 45 degrees.

18. The system of claim 15 wherein the first polarity light is S-polarized light and the second polarity light is P-polarized light.
